(19) United States
(12) Patent Application Publication
(10) Pub. No.: US 2011/0119743 A1
(43) Pub. Date: May 19, 2011

(54) COMMUNICATION OF CONTENT TO EVENT ATTENDEES

(75) Inventors: William L. Gleim, San Diego, CA (US); Ambikacharan P. Makam, San Diego, CA (US); Geetha Mangalore, San Diego, CA (US); Petr Peterka, San Diego, CA (US)

(73) Assignee: GENERAL INSTRUMENT CORPORATION, Horsham, PA (US)

(21) Appl. No.: 12/620,576

(22) Filed: Nov. 17, 2009

(51) Int. Cl. H04L 9/32; G06F 21/00

(52) U.S. Cl. 726/6; 726/7; 726/26

(57) ABSTRACT

A method is provided for enrolling and authenticating an attendee of an event or activity so that content can be delivered to a mobile device associated with the attendee. The method includes receiving an identifier of a mobile communication device associated with an authorized attendee while the attendee and the mobile communication device are in a venue at which the event or activity takes place. The mobile communication device is registered by storing the identifier in a database of authorized attendees who have entered the venue. Entitlement credentials are communicated to the mobile device that are to be further communicated from the mobile device to a content server when requesting event or activity related content therefrom.

### BACKGROUND OF THE INVENTION

Spectator events such as sporting events, entertainment events (e.g., concerts) and the like have become a multibillion dollar a year business throughout the world. For instance, millions of people attend their favorite sporting events, choosing among baseball, soccer, basketball, hockey, football, tennis, golf, auto racing, horse racing, boxing, and many others. Rather than merely watching sporting events on television, fans are willing to pay for the privilege of attending such events live in order to enjoy the spontaneity and excitement.

At certain events, limited amounts of information are shared with audience members using, for example, large screen displays. However, audience members attending these events have come to expect greater amounts of background information and detailed analysis because such information is available when watching televised events, particularly sporting events, and when accessing the Internet. Further, audience members are becoming more and more accustomed to interactivity from their use of computer games, such as fantasy sports league games, that allow them to organize teams, determine game strategies and test their skill at managing a sports team.

Additionally, an often-heard complaint from sports fans is that they missed some of the action because they could not see or did not know precisely what was happening. For example, any particular seat location affords its occupant only a single view of a playing field. In addition, some locations fail to offer an unobstructed view of the entire field. On other occasions a technical ruling made by a game official is not fully explained to those in attendance but is extensively analyzed by television and/or radio announcers, often with one or more instant replays of the event in question. Fans sometimes resort to carrying conventional portable radio and TV receivers to games, whereby they obtain game commentary, instant replays, and the like to complement what they directly observe or obtain from the stadium's own announcers, scoreboards, and video displays.

Accordingly, in order to continue attracting live audiences to attend these large venues, promoters have an incentive to provide audience members with an enhanced experience. Recently, for instance, promoters have begun to take advantage of the ever increasing popularity of mobile telecommunications devices (e.g. cellular phones), which more and more people carry with them throughout the day. The capabilities of these devices have been increasing over time so that they now provide data as well as conventional voice calls. Many mobile devices are even capable of connecting to the Internet via their wireless networks.

Event attendees are sometimes able to receive event-related information on their mobile communication devices. Such information may allow an attendee to view replays and receive analysis and commentary similar to what they might receive when watching the event on television. In addition, attendees can receive other information that allows attendees to purchase tickets to other events that may be of interest, to participate in online gaming while at the event, and purchase souvenirs (e.g., an video of the event or highlights thereof). The event promoter may also push content to attendees that give them the opportunity to promote related events, market merchandize, offer on-demand content and so on.

Known systems that deliver event-related content to event attendees roughly fall into one of two categories. In the first, an attendee may receive event-related content while at the venue at which the event is being held. The attendee registers for the content when arriving at the venue or at some time thereafter. In the second category, the attendee registers before attending the event by using a PC or the like. The content can then be delivered to the attendee while at the event or after the event on the attendee's PC or television.

The foregoing considerations apply to additional forms of entertainment that are associated with specific and defined programmatic content having an identifiable duration, such as the content provided by an athletic event, a musical or theatrical performance, or the like. Similar enhancements are also sought in connection with forms of entertainment that do not entail specific programmatic content. For example, persons patronize museums, casinos, theme parks, agricultural fairs or similar expositions, trade shows, conventions, or the like recognize entertainment value, whether or not such situations and activities include specific programmatic content having a generally defined duration as part or all of their experience.

Conventional approaches to deliver event-related content have had limited acceptance by users. It is often inconvenient for user to preregister before the event. Users are also often in large crowds while entering a venue in a short period of time before the start of an event, so it is often inconvenient for them to take the time to manually register while entering a venue.

### SUMMARY

In accordance with one aspect of the invention, a method is provided for enrolling and authenticating an attendee of an event or activity so that content can be delivered to a mobile device associated with the attendee. The method includes receiving an identifier of a mobile communication device associated with an authorized attendee while the attendee and the mobile communication device are in a venue at which the event or activity takes place. The mobile communication device is registered by storing the identifier in a database of authorized attendees who have entered the venue. Entitlement credentials are communicated to the mobile device that are to be further communicated from the mobile device to a content server when requesting event or activity related content therefrom.

In accordance with another aspect of the invention, a system is provided for enrolling and authenticating an attendee of an event or activity so that content can be delivered to a mobile device associated with the attendee. The system includes a short-range retrieval device for establishing short-range communication with a mobile communication device associated with the attendee and for receiving an identifier therefrom. The short-range retrieval device is located in a venue at which the event or activity takes place. The system also includes a communication network associated with the venue and an event registry in communication with the short-range retrieval device over the communication network. The event registry is configured to (i) receive the identifier from the short-range device, (ii) register the mobile communication device by storing the identifier in a database of authorized attendees who have entered the venue and (iii) communicate entitlement credentials to the mobile device that allow the mobile device to receive event or activity related content from a content server in a secure manner.

### BRIEF DESCRIPTION OF THE DRAWINGS

FIG. 1 shows an illustrative venue at which attendees employ mobile communication devices to receive event-related content.

FIG. 2 is schematic diagram of one example of a system for enrolling, authenticating and provisioning an authorized attendee of an event or activity to receive event-related or other content.

FIG. 3 shows a high-level signaling or call flow diagram showing one example of the interactions between the various network elements shown in FIG. 2.

FIG. 4 is a flowchart showing one example of a method for receiving content on a mobile device.

### DETAILED DESCRIPTION

At the outset it should be understood that the term “venue” as used herein refers to a place or location at which an event or activity takes place. Individuals attending the event or activity generally need to be admitted to the venue in order to become an authorized attendee. As noted above, such venues may include, by way of illustration, stadiums, theatres, museums, casinos, cruise ships, theme parks, agricultural fairs or similar expositions, trade shows, conventions, or the like. Moreover, any particular venue may sometimes encompass penumbral locations such as parking lots, lawns, walkways, and the like, provided that these locations are only accessible to authorized attendees at the time of the event or activity.

The events or activities that take place in the venue may be associated with specific and defined programmatic content having an identifiable duration, such as the content provided by an athletic event, a musical or theatrical performance, or the like. On the other hand, attendees experience some events or activities while patronizing a venue such as a museum, casino, cruise ship, theme park, agricultural fair, trade show, convention, or the like, which may or may not include specific programmatic content having a generally defined duration as part or all of the activity. In some instances, the totality of activities has a duration bounded by opening and closing hours of a museum, park, fairgrounds, convention hall, or the like. In other forms of entertainment, e.g. at casinos, activity often continues around the clock. It is to be understood that the present invention relates to events and activities either with or without the foregoing specific programmatic content and defined duration.

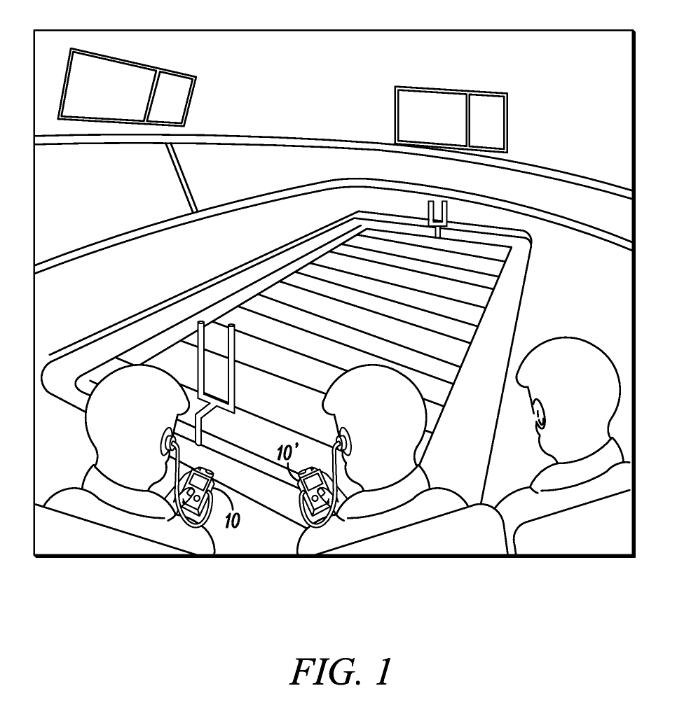

FIG. 1 shows an illustrative venue at which attendees employ mobile communication devices 10 and 10′ to receive event-related content. Although this example depicts the venue as a large, outdoor stadium it will be understood that the techniques, systems and method described herein may also be practiced at venues of other types. The mobile communication device may be any suitable wireless device, including conventional cellular telephones, PCS handset devices, personal digital assistants, portable media players and portable computers (e.g., notebooks and netbooks). Although these devices generally will be brought to the venue by the attendee, in some cases suitable general or special purpose communications devices may be made available at the venue for purchase or rent or given away without charge.

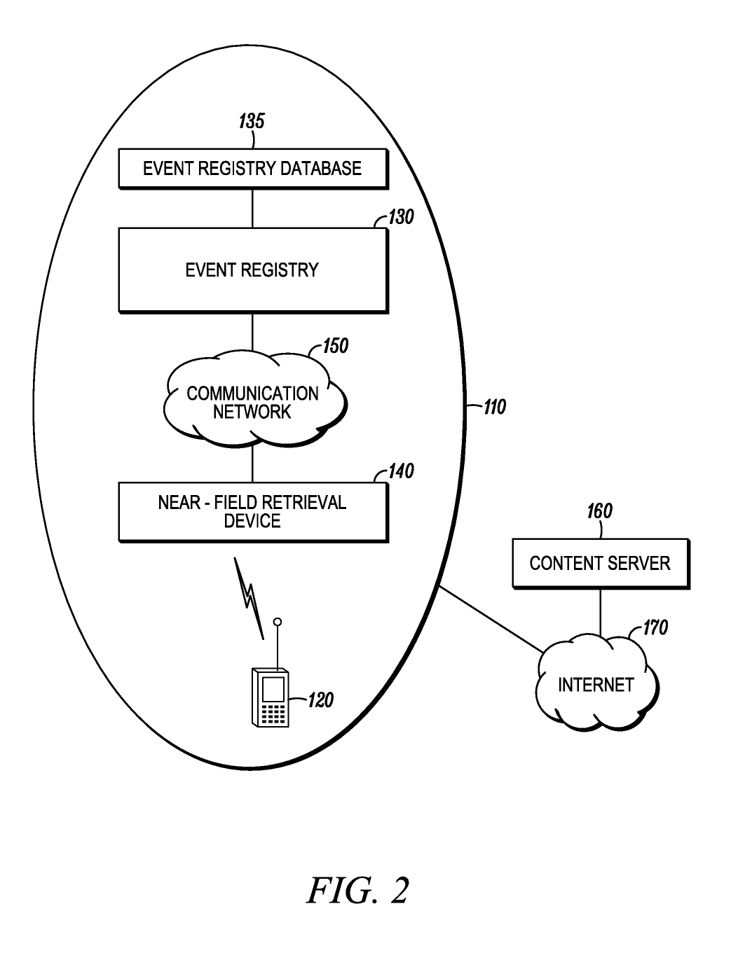

FIG. 2 is schematic diagram of one example of a system for enrolling, authenticating and provisioning an authorized attendee to receive event-related content on the attendee's mobile communication device 120 while the attendee is at the venue 110 and/or after the attendee has left the venue 110. Enrollment, authentication and provisioning, however, only occur when the authorized attendee is at the venue 110.

The system includes a near-field retrieval device 140, an event registry 130 and an event registry database 135 that is accessible to the event registry 130. The near-field retrieval device 140 and the event registry 130 are in communication with one another over a communications network 150 associated with the venue 110 such as a local area network (LAN) or a wireless LAN (WLAN) that may employ, for instance, Wi-Fi or WiMax protocols in accordance with IEEE 802.11 or IEEE 802.16(e), respectively. The system also includes a content server 160 that stores the event-related content that is to be made available to authorized attendees on their mobile devices. The content server 160 will generally not reside within the venue 110, but rather may be located anywhere (including, in some cases, the venue), provided that it can communicate with the attendees' mobile devices via a suitable network or networks, including, for instance, a packet-switched network such as the Internet 170. The mobile device 120 may access the Internet or other packet-based network using a suitable network. For instance, if the mobile device is a cellular phone, it accesses the packet-switched network over a cellular network. Illustrative cellular networks that may be employed include, for example, a 2G radio system such as a GSM (Global System for Mobile Communications), which is based on TDMA (Time Division Multiple Access) technology. In another example, the cellular network is a 3G radio system which is based on a GSM system which utilizes WCDMA (Wideband Code Division Multiple Access) technology or a UMTS (Universal Mobile Telecommunications System), 4G, LTE, WiMax, or WiFi.

In some implementations, Near-Field Communication (NFC) technology is used to initially establish communication between the system and the attendee's wireless communication device. NFC technology involves two NFC-enabled devices brought together in close proximity to transfer information. Positioning the devices in close proximity provides an added benefit of increased security and is generally believed to be an improvement over other radio wave technology, for example.

Near Field Communication (NFC) is a short-range wireless connectivity technology. NFC can be used with a variety of devices, including mobile phones and/or other portable electronic devices transferring information. NFC operates using magnetic field induction at a frequency of, for example, 13.56 MHz and transferring data at up to 424 Kbits/second. NFC provides both read and write exchange of data between electronic devices. Communication can be initiated by bringing two NFC-enabled devices in close proximity.

Communication between two NFC-compatible devices occurs when the devices are positioned, for example, within about four centimeters of one another. As an example, a motion or touch by a user with an NFC-equipped communication device can establish an NFC connection. The connection can be compatible with other known wireless technologies, such as Bluetooth or Wi-Fi. NFC communication technology operates according to accepted standards, such as International Standards Organization (ISO) and/or other telecommunications standards, for example. Due to the short transmission range, NFC-enabled transactions provide increased security.

A common data format called NDEF has been defined for NFC communication. This data format can be used to store and transport different types of data, including MIME-type objects, short RTD-documents, such as URLs, and the like. Using NDEF, binary records are used which can hold different types of objects. NFC as used herein includes, but is not limited to, NFCIP-1 and NFCIP-2, which are standardized in ECMA-340 and ECMA-352, respectively.

Of course, other short-range communication technologies other than NFC may be employed to establish communication with the attendee's mobile device after the attendee has entered the venue. The primary considerations in selecting an appropriate short-range communication technology should be its ability to easily establish secure communications when the attendee has been authorized to enter a venue (by e.g., presenting a ticket) and is within the perimeter of the venue but not outside of it. For purposes of illustration only the short-range communication technology will be referred to in what follows as employing an NFC protocol, which is now available on a growing number of wireless communication devices. Of course, other short-range communication technologies such as Bluetooth, for example, may be employed. Regardless of the technology that is employed, the retrieval device 140 should be located sufficiently far from the perimeter of the venue so that a wireless communication device cannot communicate with it from outside the venue. This is a more important consideration in the case of Bluetooth since it has a significantly greater range than NFC technology.

At some time after an authorized attendee has entered the venue the attendee's NFC-equipped mobile communication device 120 is detected by the NFC retrieval device 140 (e.g. at or near the venue entrance gate, or at individual sections (balconies, etc.) inside the venue) and signals the mobile communication device to present its unique host identifier. The NFC retrieval device 140, in turn, communicates the host identifier to the event registry 130 over network 150. The event registry 130 stores the host identifier in the database 135. In this way the attendee's communication device is added to a whitelist which indicates that the device is authorized to receive event-related content from the content server 160. Accordingly, before the content server 160 can begin delivering content, it needs verification from the event registry 130 that the mobile communication device 120 associated with the whitelisted host ID has been properly authenticated to receive the content.

In order to ensure that only properly verified mobile communication devices can receive the event-related content, a digital rights management (DRM) scheme may be employed. The DRM scheme may employ encryption and decryption keys, which are parameters used by encryption and decryption algorithms, respectively. The content server 160 uses the encryption key to encrypt the content and the attendee's mobile communication device uses the decryption key to decrypt the content. Deploying incorrect keys produces different results during both encryption and decryption. While the DRM scheme may employ public (i.e., asymmetric) key cryptography or secret (i.e., symmetric) key cryptography, for purposes of illustration the DRM scheme will be depicted herein as employing public or asymmetric key cryptography. The DRM system may also enforce access and copy protection rules specified by the content owner or service provider who makes the event-related content available, such as (1) view only, no copy, (2) time-limited copy, (3) unlimited copy, (4) single copy with no further redistribution, etc.

The DRM scheme that is used may employ any of a variety of different key management protocols. For instance, in some implementations the well-established Kerberos protocol may be employed, in which tickets are exchanged between the event registry 130 and the attendee's mobile communication device. In this case the event registry 130 may co-host a Key Distribution Center (KDC) that issues tickets to the attendee's mobile communication device. Note that the mobile communication device 120 may communicate with the event registry 130 using a different network than the Near-Field Retrieval device (e.g. the Near-Field Retrieval device may use the private network 150 while the attendee's device may use a public network). In some implementations the private network 150 should be a secure network to prevent unauthorized devices or users from adding entries to the white list.

The event registry 130 may also co-host a key management server (KMS) that provides the decryption key to the attendee's mobile communication device. Of course, as indicated in FIG. 2, the KMS may be logically, and perhaps physically, divided into an event registry server 130 and a stand-alone key management server. In other cases the KMS may be physically and logically distinct from, and in communication with, the event registry 130. For instance, the KMS may be co-hosted or co-located with the Content Server 160. In some implementations, instead of a Kerberos protocol, another key management protocol that may be employed and which also uses tickets is shown in U.S. Pat. No. 7,243,366, which is hereby incorporated by reference in its entirety, and which is referred to as the IPRM (Internet Protocol Rights Management) system.

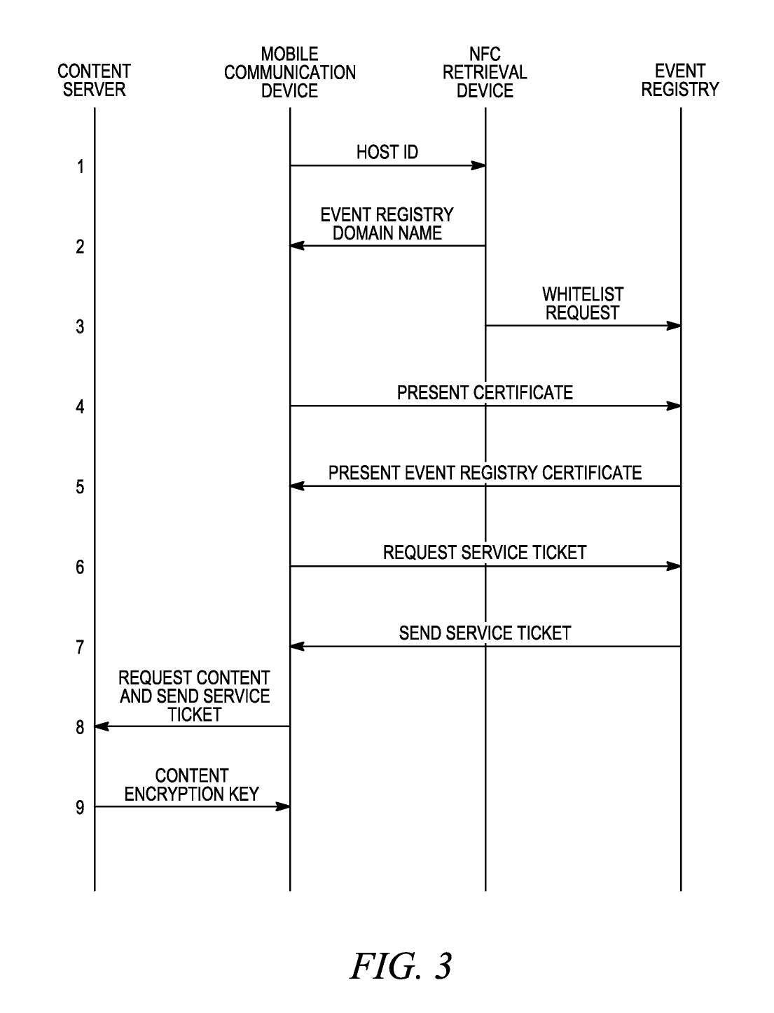

FIG. 3 shows a high-level signaling or call flow diagram that will be used to facilitate an understanding of the process by which an attendee gains access to event or activity related content. The signaling diagram shows one example of the interactions between the various network elements shown in FIG. 2. In this embodiment, the functionality of the KDC is located in the Event Registry 130 while the KMS functionality is located in the Content Server 160. Other configurations are of course also possible.

The enrollment and authentication process begins when the attendee has entered the venue, typically by presenting a physical ticket or other indicia indicating that the attendee is indeed authorized to enter the venue for the event or activity. As indicated by message 1 in FIG. 3, once the attendee has been authorized in this manner the attendee's mobile communication device transmits its unique host ID to the NFC retrieval device. Only authorized event attendees can become authorized recipients of the event-related content provided by the content server because the NFC retrieval device is located within the perimeter of the venue.

In response to receipt of the host ID, the NFC retrieval device sends the network address (e.g., the fully qualified domain name) of the event registry to the mobile device (message 2). In addition, the NFC retrieval device sends the host ID to the event registry (message 3), which stores the host ID in an event whitelist in the event registry database. The whitelist maintains the host ID of the mobile devices associated with all the attendees who are to be authorized recipients of the event-related content. The whitelist may also include additional information about the user, such as which gate was used to enter the venue (e.g. the VIP gate, vs. public gate), which section the attendee is sitting in, what kind of ticket the attendee purchased (e.g. if the physical ticket's bar code is read at the same time that the communication device is detected by the NFC retrieval device). This information may be used to differentiate the content or tier of content to which each user is entitled.

Next, the mobile device presents its digital certificate (e.g., a factory-installed X.509 certificate) to the event registry in order to verify its credentials (message 4). The mobile device sends the certificate to the event registry at its fully qualified domain name that was provided by the NFC retrieval device, typically over the Internet, local WiFi or other suitable network. The event registry validates the host ID found in the certificate against the host IDs stored in the whitelist. If there is a match, the event registry creates a record that includes the mobile device's host ID and its public key that is available from its digital certificate. The record is stored in the event registry database.

After the record has been created the event registry may optionally send its own certificate to the mobile device (message 5). The certificate can be used to protect the integrity of any future messages that may be communicated between the mobile device and the event registry.

At this point the certificate exchange process is complete and thus the enrollment and authentication process for the attendee's mobile device is also complete. Strictly speaking, any further communication between the mobile device and the event registry or the content server does not need to be performed while the mobile device is within the perimeter of the venue. Nor does the mobile device need to communicate with the event registry over the venue's LAN or WLAN, although this may well be the case.

Next, in order to access the content server, the mobile device requests an authentication service ticket from the event registry (message 6). In response, the event registry sends the mobile device the URL of the content server and an authentication service ticket (message 7). The authentication service ticket includes a KMS session key from the event registry. Once it receives the service ticket the mobile device is provisioned to receive content from the content server. At any subsequent point in time, either while at the venue or after leaving the venue, the attendee can use the mobile device to access content from the content server (presuming, of course, that the content continues to be available and the attendee is accessing the content in accordance with any DRM rules). The request for content that is sent to the content server includes the authentication service ticket (message 8).

In response to receipt of the request for content, the content server verifies that the mobile device is authorized to receive content by examining the service ticket and sends to the mobile device the content encryption key and the content rights associated to the content encryption key (message 9). The content encryption key is encrypted with the KMS session key. At this point the content server can now deliver content to the mobile device. The content that is delivered may be content that the attendee specifically requests. That is, the attendee may pull content from the content server. In some cases content may also (or alternatively) be pushed to the mobile device by the content server.

The nature and type of content that the attendee can receive will generally be determined by the event promoter, venue owner and/or the network service provider. Some types of content may be particularly attractive to send to the attendee while the event or activity is in progress. Other types of content may be more attractive to attendees after the event or activity is over and they have left the venue. Of course, the content may also depend on the nature of the event or activity. Some examples of the type of content that may be provided include links to web pages with up-to-date news relating to the event or activity. For instance, if the event is a sports event, game highlights may be provided as well as links to news about the team and players. Other content may offer merchandize for sale, perhaps including a video of the event (or highlights thereof) and special merchandize that is not offered elsewhere. Yet other content that may be provided includes icons, screensavers, sound bites and the like, which can be automatically downloaded to the mobile device when the attendee accesses the content service.

In the simplest case, all authenticated attendees are fully provisioned to receive all the available services from the content server. In other cases, however, a more flexible approach may be offered with tiered services. For instance, in one implementation each authorized attendee would have access to a default tier or set of services. Additional services may be made available based on the tier of the physical ticket that the attendee has used to gain authorized access to the venue. That is, attendees who have more expensive tickets, for example, may receive a higher tier of services than attendees who have less expensive tickets. In other words, there is a pairing between each physical ticket and a service tier provided by the content server. Each service tier may maintain its own whitelist in the event registry database.

In some implementations the retrieval device can determine the appropriate service tier of the attendee by tracking and signaling to the event registry the location, gate, section and/or balcony of the particular retrieval device at which the attendee entered. In addition, if a physical (e.g. paper) ticket is also scanned upon entry, the type of ticket may be also included in the whitelist. This information can be subsequently included in the ticket issued to the communication device by the event registry. In turn, the KMS will use this information to determine the tier of content to which the user is entitled.

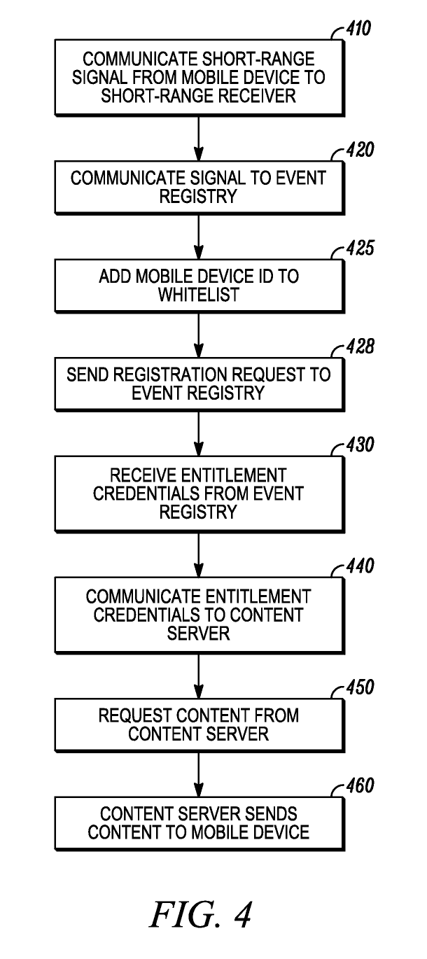

FIG. 4 is a flowchart showing one example of a method for receiving content on a mobile device. The method begins in step 410 when a short-range signal is communicated from the mobile device to a short-range receiver located within a venue that the attendee has been authorized to enter. The short-range signal (e.g, a near-field signal) includes an identifier of the mobile device such as its host identifier. The mobile device is carried by an attendee while the attendee is at the venue. The short range receiver sends the short-range signal to an event registry in step 420. The signal sent to the event registry includes at least the unique device host ID. In response to the communication of the short-range signal, the event registry adds the device host ID to the whitelist in step 425. In step 428 the mobile device sends a registration request, including at least the device ID and/or the device certificate, to the event registry (e.g. the KDC), which checks the device ID against the existing whitelist. If the device ID is on the whitelist, the event registry updates the event database with at least the device's certificate or public key and sends entitlement credentials (e.g. in the form of a ticket) for accessing content from the content server in step 430 (note that step 430 may be performed in one or more transactions). When the attendee wishes to receive content from the content server, the mobile device communicates the entitlement credentials and a selected content identifier to the content server (where the KMS functionality resides in this example) over a wireless network in step 440, which, if the entitlement credentials are sufficient, returns the selected content's encryption key. In step 450 the mobile device sends a message requesting the content over the wireless network to the content server. In response, the content server sends the requested content to the mobile device over the wireless network in step 460, at which time the device may start decrypting and rendering the content.

The content may be requested by, and sent to, the mobile device while the attendee is at the venue or after he or she has left the venue. If the content is accessed after leaving the venue, it may be obtained using a different network (e.g. the user's home broadband Internet access network). In addition, some content may be stored persistently on the mobile device and consumed later after the event for a predetermined time interval, a predetermined number of viewings, or in some cases it may be further shared with the user's other devices.

The processes described above may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable storage medium. The instructions may also be created using source code or any other known computer-aided design tool. A computer readable storage medium may be any medium capable of carrying those instructions and include a CD-ROM, DVD, magnetic or other optical disc, tape, or silicon memory (e.g., removable, non-removable, volatile or non-volatile). Optionally, for security/robustness reasons, at least the DRM portion of the application residing on the mobile device and the server may use secure hardware or hardened software.

1. A method for enrolling and authenticating an attendee of an event or activity so that content can be delivered to a mobile device associated with the attendee, comprising:
receiving an identifier of a mobile communication device associated with an authorized attendee while the attendee and the mobile communication device are in a venue at which the event or activity takes place;
registering the mobile communication device by storing the identifier in a database of authorized attendees who have entered the venue; and
communicating entitlement credentials to the mobile device that are to be further communicated from the mobile device to a content server when requesting event or activity related content therefrom.

2. The method of claim 1 wherein receiving the identifier of the mobile communication device includes receiving from the mobile device a short-range communication signal that includes the identifier.

3. The method of claim 2 wherein registering the mobile device includes forwarding the received short-range communication signal to an event registry over a communication network associated with the venue.

4. The method of claim 3 further comprising communicating a network address of the event registry to the mobile device.

5. The method of claim 4 wherein communicating entitlement credentials includes receiving from the mobile device a digital certificate verifying identification of the mobile device, said digital certificate being sent to the event registry at the network address.

6. The method of claim 1 wherein communication of entitlement credentials is performed in accordance with an Internet Protocol Rights Management (IPRM) procedure.

7. The method of claim 3 wherein the communication signal includes information that differentiates attendees based on tiers of content to which they are entitled.

8. The method of claim 1 wherein the content server is located outside of the venue and the mobile device is configured to communicate with the content server over the Internet.

9. The method of claim 1 wherein the content server is located outside of the venue and the mobile device is configured to communicate with the content server after the event or activity to receive additional content.

10. A system for enrolling and authenticating an attendee of an event or activity so that content can be delivered to a mobile device associated with the attendee, comprising:
a short-range retrieval device for establishing short-range communication with a mobile communication device associated with the attendee and receiving an identifier therefrom, wherein the short-range retrieval device is located in a venue at which the event or activity takes place;
a communication network associated with the venue; and
an event registry in communication with the short-range retrieval device over the communication network, said event registry being configured to (i) receive the identifier from the short-range device, (ii) register the mobile communication device by storing the identifier in a database of authorized attendees who have entered the venue and (iii) communicate entitlement credentials to the mobile device that allow the mobile device to receive event or activity related content from a content server in a secure manner.

11. The system of claim 10 wherein the short-range retrieval device is a near-field retrieval device that operates in accordance with a near-field with a near-field communication (NFC) protocol.

12. The system of claim 10 wherein the event registry is further configured to receive from the mobile device a digital certificate verifying its identification prior to communicating the entitlement credentials.

13. The system of claim 10 wherein the event registry is further configured to communicate the entitlement credentials in accordance with an Internet Protocol Rights Management (IPRM) procedure.

14. The system of claim 10 wherein the content server is further configured to communicate content encryption keys and digital rights to the content in accordance with an Internet Protocol Rights Management (IPRM) procedure.

15. The system of claim 10 wherein the event registry is further configured to communicate the entitlement credentials by sending a service ticket to the mobile device.

16. A method of receiving content on a mobile device, comprising:
communicating a short-range signal that includes an identifier of a mobile device associated with an attendee while the attendee is at a venue that the attendee has been authorized to enter;
receiving, in response to the communication of the short-range signal, entitlement credentials for accessing content from a content server;
communicating the entitlement credentials to the content server over a wireless network; and
receiving content in a secure manner from the content server over the wireless network for rendering on the mobile device.

17. The method of claim 16 further comprising requesting receipt of selected content from the content server and receiving the selected content from the content server over the wireless network for rendering on the mobile device.

18. The method of claim 16 further comprising receiving content that has been pushed to the mobile device by the content server after the entitlement credentials have been communicated.

19. The method of claim 16 wherein the content is received while the attendee is at the venue.

20. The method of claim 16 wherein the content is received after the attendee has left the venue.

21. The method of claim 16 further comprising receiving, along with the content, content rights that includes access and copy protection rules associated with the content.

22. The method of claim 16 wherein the content that is available is divided into a plurality of tiers and further comprising allowing mobile devices access to any one of the tiers based on a tier of a physical ticket used by respective attendees associated with the mobile devices to enter the venue.

23. The method of claim 16 wherein the content that is available is divided into a plurality of tiers and further comprising allowing mobile devices access to any one of the tiers based on a seating location of respective attendees associated with the mobile devices.
